(19) United States
(12) Patent Application Publication
(10) Pub. No.: US 2004/0169960 A1
(43) Pub. Date: Sep. 2, 2004

(54) Head cleaning device for tape drive

(76) Inventors: Havard Hoelsaeter, Oslo (NO); Havard Holmedal, Oslo (NO); Bjarte Jegerstedt, Oslo (NO)

Correspondence Address: SCHIFF HARDIN, LLP, PATENT DEPARTMENT, 6600 SEARS TOWER, CHICAGO, IL, 60606-6473, US

(21) Appl. No.: 10/376,690

(22) Filed: Feb. 27, 2003

(51) Int. Cl. G11B 5/41

(52) U.S. Cl. 360/128

(57) ABSTRACT

A cleaning device for cleaning a magnetic recording head in a tape drive, which receives a single-reel cartridge therein and from which magnetic recording tape is extracted and engaged with a take-up reel in the tape drive, the assembly used to extract the tape from the cartridge and engage it with the take-up reel has bristles thereon which pass by the magnetic recording head and brush the magnetic recording head during each threading and de-threading procedure between the cartridge and the take-up reel. The threading and de-threading can be uninterrupted, or can be paused at a point where the bristles are in contact with the magnetic recording head, and either of the bristles being caused to oscillate during the pause, or the magnetic recording head being moved during the pause, to brush the magnetic recording head to clean it. The magnetic recording head thus is cleaned automatically every time a cartridge is loaded into the tape drive.

### BACKGROUND OF THE INVENTION

1. Field of the Invention

The present invention is directed to a device for cleaning the magnetic recording head (read/write head) of a tape drive for magnetic recording tape.

2. Related Application

The present application is related to co-pending application Attorney Docket No. P03,0029 (System For Extracting Magnetic Recording Tape From A Tape Cartridge For Engagement For A Take-Up Reel,” H\dot{a}vard Holstaeter) filed simultaneously herewith, the teachings of which are incorporated herein by reference.

3. Description of the Prior Art

For transferring data to and from a magnetic recording tape, one or more transducers are disposed in a recording head across which the magnetic recording tape passes to record data on and/or read data from the tape. Particularly when the tape is moved at high speeds across the recording head, air is entrained with the moving magnetic tape which, despite efforts to maintain a clean environment, will carry dust and particulate debris. Moreover, due to mechanical interaction with the recording head itself, and other components such as capstans and outriggers, the metallic oxide on the magnetic recording tape will wear and also create dust and particulate debris.

There is therefore a need to regularly clean the transducer surfaces of the recording head, because accumulated dust and debris can produce errors in the data transfer, cause scratches on the recording tape, and otherwise degrade the overall performance of the tape drive.

In tape drives wherein the recording head is relatively easily accessible from the exterior of the tape drive, manual cleaning with a brush or the like can be undertaken at periodic intervals. This approach, however, requires that attending personnel adhere to a regular maintenance schedule, and also requires that the tape drive be non-operational during the cleaning.

It is also known to provide special cleaning tape cartridges, which are insertable into the tape drive in place of a data-carrying tape cartridge, for the specific purpose of cleaning the recording head. This approach also requires that attending personnel follow a regular schedule to periodically substitute the tape cleaning cartridge in place of a data-carrying cartridge. As in the solution embodying manual cleaning, the tape drive is not available for data transfer activity while the tape-cleaning cartridge is in place.

### SUMMARY OF THE INVENTION

It is an object of the present invention to provide a head cleaning device for a magnetic recording head which does not require any manual intervention or monitoring, and which does not result in any down time during which the tape drive is not usable for data transfer purposes.

This object is achieved in accordance with the principles of the present invention in a head cleaning device for a magnetic tape drive wherein the tape transfer device, which is used to transfer a tape from a single-reel cartridge to a take-up reel in the drive, includes an element which passes by the recording head during each threading and unthreading procedure, and which carries a brush that cleans the recording head each time this element passes by the recording head.

The inventive head cleaning device is suitable for use in a tape drive which has a take-up reel, and which receives a single-reel cartridge. Magnetic recording tape is wound on a single reel in the cartridge, and a free end of the tape in the cartridge is accessible through an opening in the cartridge. The free end of the tape is provided with a leader pin, which is gripped, while in the tape cartridge, by a gripper element of a threading or tape extraction mechanism in the tape drive. The threading or extraction mechanism pulls the free end of the magnetic tape out of the cartridge and moves it along a path which proceeds past the magnetic recording head, so as to engage the leader pin at the free end of the recording tape with the hub of the take-up reel in the tape drive. As the take-up reel is operated in the tape drive, the recording tape is moved past the recording head for data transfer purposes. The tape drive also includes a drive that is temporarily engageable with the cartridge, when the cartridge is inserted in the tape drive, to move the tape in the opposite direction.

In such an extraction or threading mechanism, every time the recording tape is threaded onto the take-up reel, or is unthreaded therefrom after a data transfer procedure has ended, the gripper portion of the mechanism, which engages the leader pin at the free end of the magnetic recording tape, must pass by the magnetic recording head. This affords the opportunity to provide a brush on one of the elements of the gripper mechanism, which will interact with and clean the recording head each time the brush passes by the recording head. Thus, the recording head will automatically be cleaned twice (once during threading and once during unthreading) every time a single-reel cartridge is loaded into the tape drive. Since the cleaning occurs automatically after a single-reel cartridge is loaded into the tape drive, no human intervention is required to effect the cleaning, and there is no need to set up a maintenance schedule for routine cleaning of the recording head. Moreover, since the cleaning occurs during the threading and de-threading processes, which must occur anyway when a cartridge is loaded into the drive, no extra time must be reserved for cleaning, and the cleaning does not detract from the time that the tape drive is available for data transfer purposes.

Although cleaning can proceed as described above merely by passage of the brush or bristles across the recording head during each threading and de-threading procedure, without stoppage of the threading or rethreading procedure, a more thorough cleaning can be accomplished if the threading or de-threading procedure is briefly interrupted by stopping the threading/de-threading mechanism when the bristles are adjacent the magnetic recording head. The threading/de-threading mechanism can then be operated to oscillate the brush or bristles back and forth alternatingly in the threading direction and de-threading direction, thereby brushing the recording head and cleaning it.

Alternatively, every tape drive used for data recording purposes is provided with a head stepping mechanism, for moving the recording head transversely to the longitudinal direction of the recording tape, so as to accurately position the transducers of the recording head in alignment with the data tracks on the magnetic tape, which proceed parallel to the edges of the recording tape. This head stepping mechanism can be used to assist in the cleaning procedure, by moving the recording head back and forth in the aforementioned transverse direction while the brush is located adjacent the recording head. Of course, it is also possible to clean the recording head by a combination of the oscillatory movement of the threading/de-threading mechanism and the operation of the head stepping mechanism.

### DESCRIPTION OF THE DRAWINGS

FIG. 1 is a perspective view of a tape guide, for guiding a magnetic recording tape from a single-reel cartridge to a take-up reel in a tape drive, in which components of a head cleaning device in accordance with the invention are located.

FIG. 2 shows a gripper follower having head cleaning bristles thereon as used in the head cleaning device in accordance with the invention.

FIG. 3 shows the gripper in the head cleaning device in accordance with the invention.

FIG. 4 shows the components of the head cleaning device in accordance with the invention of FIG. 1, before reaching the recording head in a threading procedure.

FIG. 5 is an enlarged extract from FIG. 1, showing cleaning of the magnetic recording head by the inventive head cleaning device.

### DESCRIPTION OF THE PREFERRED EMBODIMENTS

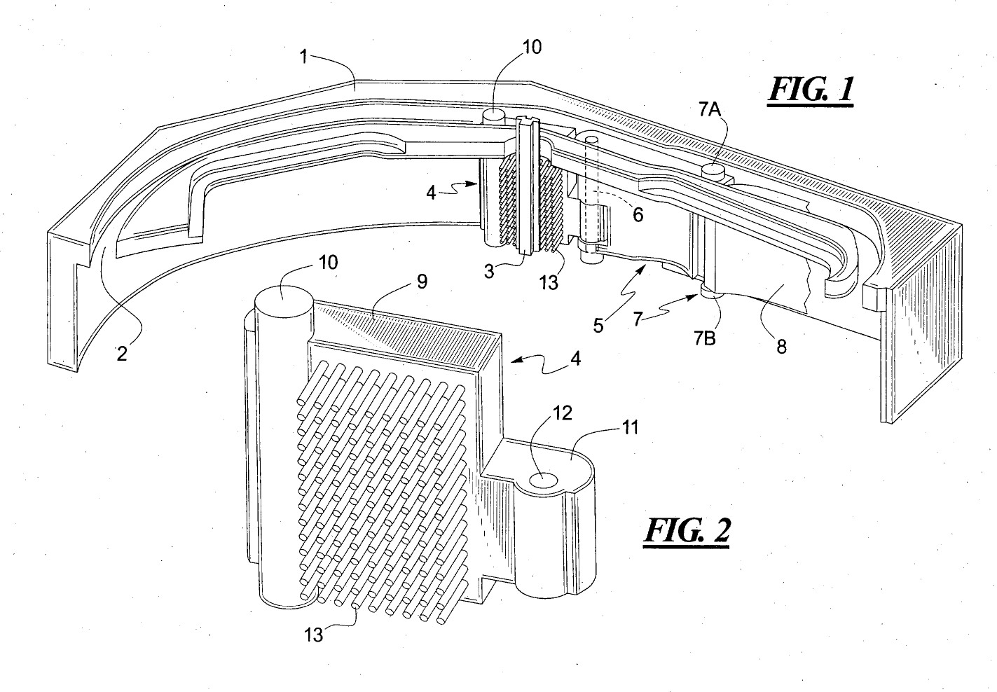

The head cleaning device shown in FIGS. 1-5 is operated by a threading/de-threading (tape extraction) mechanism as described in co-pending application P03,0029, noted above. All components which are utilized for cleaning the recording head in accordance with the invention are shown in FIGS. 1-5, and a suitable mechanism for moving those components, in a threading and de-threading procedure, is described in P03,0029. It is only important that this mechanism interact with the head cleaning device in the manner described below, but the details of the components of the mechanism itself is not important to the subject matter of the head cleaning device.

FIG. 1 shows a tape guide 1 which is located in a tape drive (not shown) of the type wherein a single-reel cartridge, containing magnetic tape on a reel in the cartridge is loaded into the tape drive, and the tape is extracted from the cartridge and moved through a channel 2 in the tape guide 1 so as to engage the free end of the tape with the hub of a take-up reel (not shown) in the tape drive. When the tape cartridge is loaded into the tape drive, an access opening in the tape drive, via which the free end of the magnetic recording tape therein can be gripped, is located near the right end of the tape guide 1 shown in FIG. 1, and the take-up reel is located near the left end of the tape guide 1.

A magnetic recording head 3, containing read and/or write transducers, is disposed in the tape drive next to the channel 2 in the tape guide 1. The recording. head 3 is mounted in a known manner in a suitable head stepping device, which, for conventional purposes unrelated to cleaning of the recording head 3, moves the recording head vertically upwardly and downwardly (given the orientation shown in FIG. 1).

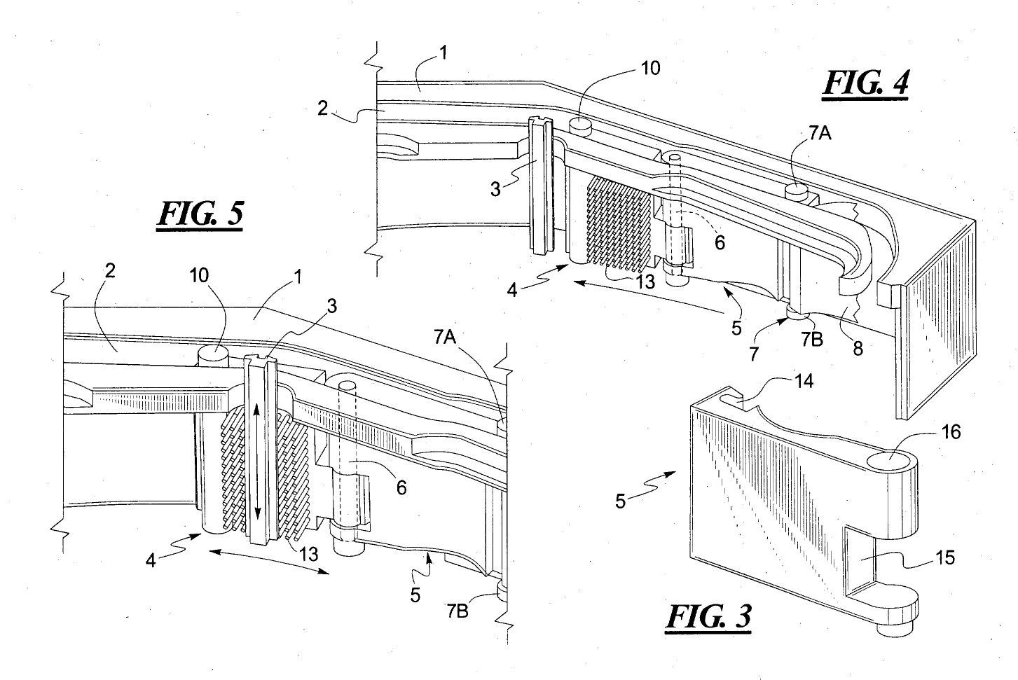

The basic components of the head cleaning device of the invention are a gripper follower 4 and a gripper 5, which are separately shown respectively in FIGS. 2 and 3. In the tape drive, the gripper follower 4 and gripper 5 are engaged with each other in a hinged arrangement by means of a pin or axle 6 of the aforementioned operating mechanism. The pin 6 is moved by a lever arm to proceed along the path of the channel 2 in the tape guide 1. The pin 6 is moved toward the left in FIG. 1 for a threading procedure and is moved toward the right in FIG. 1 for a de-threading procedure. Movement of the pin 6 in these directions causes movement of the gripper follower 4 and the gripper 5 through the channel 2 in these directions as well.

As shown in FIG. 2, the gripper follower 4 has a body portion 9 with a peg or pin 10 integrated therein which projects upwardly from the body portion 9, and serves as a guide, as shown in FIG. 1, as the gripper follower 4 is moved through the channel 2, to maintain the gripper follower 4 aligned in the channel 2. The body portion 9 also has a projection 11 with a bore 12 therein, and carries a set of bristles 13.

As shown in FIG. 3, the gripper 5 has a recess 15, in which the projection 11 of the gripper follower is received, and a bore 16 in a portion of the gripper follower 5 above the recess 15. The aforementioned pin 6 proceeds through the bore 16 in the gripper 5 and through the bore 12 in the projection 11 of the gripper follower 4 in the recess 15 of the gripper 5, to form the aforementioned hinged engagement between the gripper follower 4 and the gripper 5.

At its opposite end, the gripper 5 has a hook 14. In a manner described in detail in the aforementioned co-pending application P03,0029, when the gripper 5 is moved into a single-reel cartridge loaded into the tape drive, the hook 14 engages a leader pin 7, shown in FIG. 1, connected to the free end of a magnetic recording tape 8. The leader pin 7 has an upper flange 7A and a lower 7B. The upper flange 7A slides in the channel 2, in the same manner as the peg 10, to assist in maintaining alignment in the channel 2.

FIG. 4 illustrates the arrangement of FIG. 1 during a threading procedure, wherein the gripper follower 4 and the gripper 5, with the recording tape 8 engage therewith, are moved in the direction of the curved arrow shown in FIG. 4. This movement can proceed uninterrupted as the bristles 13 pass by the magnetic recording head 3, thereby briefing brushing the magnetic recording head 3 to clean it. The same occurs during a de-threading procedure wherein the components are moved in the direction opposite to the direction of the arrow shown in FIG. 4.

Alternatively, as shown in FIG. 5, the threading or de-threading procedure can be briefly interrupted at a point where the gripper follower 4 comes to be adjacent the magnetic recording head 3, with the bristles 13 in contact with the magnetic recording head 3. During this brief stoppage, the aforementioned operating mechanism can be caused to oscillate to move the gripper follower 4 back and forth in the directions of the curved double arrow shown in FIG. 5 to effect a more thorough cleaning of the magnetic recording head 3. Alternatively, or in addition thereto, the magnetic recording head 3 can be moved upwardly and downwardly, as indicated by the double vertical arrow in FIG. 5, by the head stepping mechanism which is conventionally provided to align the transducers of the magnetic recording head 3 with data tracks on the tape 8. This also effects cleaning of the recording head 3 by the bristles 13.

As desired, the active brushing shown in the embodiment of FIG. 5 can take place during every threading and/or de-threading procedure. Alternatively, the “brush-by” cleaning which occurs without stoppage of the threading or de-threading procedure can be routinely employed, with the operating mechanism of the tape drive being suitably controlled to effect the more thorough brushing in the embodiment of FIG. 5 only in predetermined threading or de-threading procedures, such as at every other procedure, every third procedure, etc.

Although modifications and changes may be suggested by those skilled in the art, it is the intention of the inventors to embody within the patent warranted hereon all changes and modifications as reasonably and properly come within the scope of their contribution to the art.

We claim as our invention:

1. In a tape drive adapted to receive a single-reel cartridge containing magnetic recording tape, said tape drive having a take-up reel therein, a magnetic recording head mounted in a tape guide proceeding between said cartridge and said take-up reel, and a threading/de-threading mechanism having a pin movable through said tape guide between said cartridge and said take-up reel and past said magnetic recording head, the improvement of a cleaning device for cleaning said magnetic recording head comprising:
an assembly adapted to engage said magnetic recording tape and adapted to engage said pin of said mechanism, with said assembly and said magnetic recording tape passing by said magnetic recording head during every movement of said mechanism between said cartridge and said take-up reel; and
bristles disposed on said assembly facing toward said magnetic recording head when said assembly in said tape guide, said bristles contacting and brushing said magnetic recording head to clean said magnetic recording head during each passage of said assembly past said magnetic recording head.

2. The improvement of claim 1 wherein said assembly comprises a gripper adapted to engage said magnetic recording tape and a gripper follower on which said bristles are disposed, said gripper and said gripper follower being in hinged engagement by said pin of said mechanism.

3. The improvement of claim 1 wherein said mechanism interrupts movement of said assembly in said tape guide when said bristles are in contact with said magnetic recording head and oscillates said assembly in said tape guide, in alternating directions between said take-up reel and said cartridge, to clean said magnetic recording head.

4. The improvement of claim 1 wherein said tape drive has a head stepping mechanism connected to said magnetic recording head for moving said magnetic recording head in opposite directions transverse to said direction of movement between said cartridge and said take-up reel, and wherein said mechanism interrupts movement of said assembly through said tape guide between said cartridge and said take-up reel at a point where said bristles are in contact with said magnetic recording head and wherein said head stepping mechanism is operated to move said magnetic recording head in said opposite directions transverse to said direction between said cartridge and said take-up reel to clean said magnetic recording head.

5. A method for cleaning for a magnetic recording head in a tape drive comprising the steps of:
loading a single-reel cartridge in a tape drive, said single-reel cartridge containing magnetic recording tape wound therein with an accessible free end;
providing a gripper assembly in said tape drive having bristles thereon;
engaging said gripper assembly with said free end of said tape in said cartridge and extracting said tape from said cartridge by moving said gripper assembly with said tape engaged therewith past a magnetic recording head and engaging said free end of said tape with a take-up reel in said tape drive; and
as said gripper assembly passes by said magnetic recording head in said tape drive between said cartridge and said take-up reel, brushing said magnetic recording head with said bristles to clean said magnetic recording head.

6. A method as claimed in claim 5 comprising brushing said magnetic recording head with said bristles without interrupting movement of said assembly between said cartridge and said take-up reel.

7. A method as claimed in claim 5 comprising the additional steps of:
interrupting said movement of said assembly between said cartridge and said take-up reel at a point where said bristles are in contact with said magnetic recording head;
while said movement of said assembly is interrupted, oscillating said assembly in opposite directions between said cartridge and said take-up reel to brush said magnetic recording head with said bristles to clean said magnetic recording head; and
resuming said movement of said assembly between said cartridge and said take-up reel.

8. A method as claimed in claim 5 comprising the additional steps of:
interrupting said movement of said assembly between said cartridge and said take-up reel at a point where said bristles are in contact with said magnetic recording head;
moving said recording head in alternating directions transversely to said direction between said cartridge and said take-up reel while said assembly is interrupted; and
resuming said movement of said assembly between said cartridge and said take-up reel.
